(19) United States
(12) Patent Application Publication
(10) Pub. No.: US 2006/0024452 A1
(43) Pub. Date: Feb. 2, 2006

(54) Aligning agent for liquid crystal and liquid-crystal display element

(75) Inventors: Mitsumasa Kondo, Chiba (JP); Masaji Akimoto, Chiba (JP); Kiyoshi Sawahata, Chiba (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Nissan Chemical Industries, Ltd., Tokyo (JP)

(21) Appl. No.: 10/529,183

(22) PCT Filed: Sep. 25, 2003
(86) PCT No.: PCT/JP03/12257

§ 371 Date: Mar. 24, 2005

(30) Foreign Application Priority Data
Sep. 25, 2002 (JP) 2002-278810

(51) Int. Cl. C09K 19/00

(52) U.S. Cl. 428/1.26

(57) ABSTRACT

To provide a liquid crystal alignment treating agent to obtain a liquid alignment film of polyamide type which, in its applications to various display devices employing nematic liquid crystal, is excellent in voltage retention, has a reduced charge accumulation and is excellent in durability against rubbing treatment, and a liquid crystal display device employing it.
A liquid crystal alignment treating agent to obtain an alignment film for nematic liquid crystal by rubbing treatment after forming a coating film, characterized in that it comprises at least one polymer selected from a polyamic acid obtained by reacting one or more tetracarboxylic dianhydrides with one or more diamines comprising at least one diamine having a structure represented by the following formula (I), and a polyimide obtained by cyclodehydration of such a polyamic acid; and a liquid crystal display device obtained by applying the liquid crystal alignment treating agent to a pair of substrates having electrodes, to form coating films, rubbing the coating film surfaces to form liquid crystal alignment films, and sandwiching nematic liquid crystal between the liquid crystal alignment films formed on the pair of substrates: 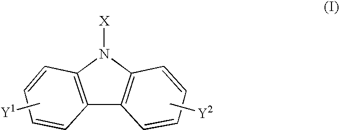
wherein X is a hydrogen atom or a monovalent organic group, and each of Y¹ and Y² is a primary amino group or a monovalent organic group having one primary amino group.

### TECHNICAL FIELD

The present invention relates to a liquid crystal alignment treating agent which presents a liquid crystal alignment film excellent in electrical properties and reliability and also excellent in liquid crystal alignment and durability against rubbing treatment of the coating film, in its application to display devices employing nematic liquid crystal, and a liquid crystal display device employing such an alignment film.

### BACKGROUND ART

At present, as display devices employing nematic liquid crystal, a twisted nematic (TN) device having a twist angle of 90°, a supertwisted nematic (STN) device having a twist angle of 180° or more, a so-called TFT liquid crystal device using a thin film transistor, and further, various types of display devices, such as a lateral electric field type liquid crystal display device improved in visual angle properties and a vertical alignment type liquid crystal display device, are practically used.

To obtain a liquid crystal alignment film for such display devices, it is industrially common to employ a method wherein a solution of a polyimide precursor, a soluble polyimide or a mixture thereof, is coated, baked and then subjected to alignment treatment by rubbing.

Properties required for the above liquid crystal alignment film naturally include basic properties such as transparency, heat resistance and chemical resistance, and they also include interfacial properties with liquid crystal such as a good liquid crystal alignment property and a liquid crystal tilt angle having a stable and proper degree, and electric properties such as a voltage retention characteristic and a charge accumulation characteristic when the liquid crystal display device is driven.

Further, from the viewpoint of production of a liquid crystal display device, storage stability of the liquid crystal alignment treating agent, properties as a varnish such as a printing property of the treating agent on a substrate, and properties such as durability against scratches or scraping in the rubbing treatment of the coating film and efficient generation and release of electrostatic charges, are also important.

Of the above properties, the electrical properties such as the charge accumulation amount and efficient release of the accumulated charge, which are considered to be influential to a residual image phenomenon, are particularly important, and various methods have been proposed. For example, a liquid crystal alignment film has been proposed whereby C-V hysteresis at the time of application of DC has been reduced by employing, as a material for a polyimide, a diamine having a specific structure having the molecular weight increased without having a polar atom such as an ether bond (JP-A-6-228061). Further, it has been proposed to employ a soluble polyimide having a nitrogen atom other than the imide group, thereby to shorten the time until a residual image be erased (JP-A-10-104638).

However, along with the progress in high performance of a liquid crystal display device, power saving of a display device and improvement of the durability under various environments, problems have become distinct such that the contrast deteriorates due to a low voltage retention in a high temperature environment, and that persistence of vision in the display is caused by accumulation of charge by continuous driving for a long time. In such a case, it is difficult to solve such two problems at the same time solely by the techniques heretofore proposed.

### DISCLOSURE OF THE INVENTION

It is an object of the present invention to provide a liquid crystal alignment treating agent to obtain a liquid alignment film of polyimide type which, in its applications to various display devices employing nematic liquid crystal, is excellent in voltage retention, has a reduced charge accumulation and is excellent in durability against rubbing treatment, and a liquid crystal display device employing it.

The present inventors have made diligent studies on measures to overcome the above problems, and as a result, it has been found that by incorporating a specific structure to the liquid crystal alignment treating agent of polyimide type, the liquid alignment property and the resistance against rubbing treatment of the coating film will be excellent, and it is possible to improve electrical properties such as the property of accumulation charge and the property of voltage retention.

Namely, the liquid crystal alignment treating agent of the present invention is a liquid crystal alignment treating agent to obtain an alignment film for nematic liquid crystal by rubbing treatment after forming a coating film, characterized in that it comprises at least one polymer selected from a polyamic acid obtained by reacting one or more tetracarboxylic dianhydrides with one or more diamines comprising at least one diamine having a structure represented by the following formula (I), and a polyimide obtained by cyclodehydration of such a polyamic acid: 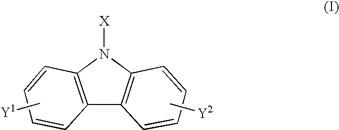
wherein X is a hydrogen atom or a monovalent organic group, and each of Y¹ and Y² is a primary amino group or a monovalent organic group having one primary amino group.

### BEST MODE FOR CARRYING OUT THE INVENTION

Further, the liquid crystal display device of the present invention is a liquid crystal display device obtained by applying a liquid crystal alignment treating agent comprising at least one polymer selected from polyamic acid obtained by reacting one or more tetracarboxylic dianhydrides with one or more diamines comprising at least one diamine having a structure represented by the above formula (I), and a polyimide obtained by cyclohydration of such a polyamic acid, to a pair of substrates having electrodes, to form coating films, rubbing the coating film surfaces to form liquid crystal alignment films, and sandwiching nematic liquid crystal between the liquid crystal alignment films formed on the pair of substrates.

### BEST MODE FOR CARRYING OUT THE INVENTION

Now, the present invention will be described in detail.

The liquid crystal alignment treating agent of the present invention is a liquid crystal alignment treating agent which comprises at least one polymer (which will be generally referred to as the specific polymer) selected from a polyamic acid obtained by reacting one or more tetracarboxylic dianhydrides with one or more diamines comprising at least one diamine having a structure represented by the above formula (I), and a polyimide obtained by cyclodehydration of such a polyamic acid. Further, the liquid crystal alignment treating agent in the present invention represents a solution of the above specific polymer, to be used for forming a liquid crystal alignment film.

In the formula (I), each of Y¹ and Y² is a primary amino group or a monovalent organic group having one primary amino group. The diamine having a structure represented by the formula (I) is a diamine characterized by a structure wherein at any one position of 1- to 4-positions and at any one position of 5- to 8-positions, of the carbazole structure; primary amino groups are, respectively, bonded directly or via another organic group. The monovalent organic group having one primary amino group is not particularly limited, but, it may, for example, be an aminoalkyl group, an aminoalkoxy group, an aminophenyl group, an aminophenoxy group, an aminobenzyl group or an aminobenzoyl group. In the formula (I), the remaining positions of from 1- to 8-positions of the carbazole structure may be occupied by hydrogen atoms, or may be substituted by a substituent other than a primary amino group, such as an alkyl group, an alkoxy group, an aromatic group, a halogen atom, an alkyl group substituted by halogen, an alkoxyl group substituted by halogen or an aromatic group substituted by halogen.

In the formula (I), X is a hydrogen atom or a monovalent organic group. X at the N-position of the carbazole structure is basically preferably a hydrogen atom, but may be substituted by a monovalent organic group. Such a monovalent organic group may, for example, be a C₁₋₂₀ alkyl group, a C₁₋₂₀ alkenyl group, a cycloalkyl group, a phenyl group, a biphenyl group, a terphenyl group or a group comprised of a combination thereof. Further, at the N-position in the carbazole structure, introduction of a substituent is relatively easy, and for the purpose of imparting a further characteristic, a specific substituent may be introduced. For example, introduction of a substituent such as a C₆₋₂₀ alkyl group, a cycloalkyl group or a fluoroalkyl group, is effective to increase the pretilt angle of liquid crystal.

The diamine having a structure represented by the formula (I) to be used to obtain the specific polymer of the present invention, is not particularly limited so long as the above requirements are satisfied. However, for such a reason that the density of the carbazole structure can be made high when formed into a polyamic acid or a polyimide, the molecular weight of the diamine having a structure represented by the formula (I) is preferably as small as possible. As a preferred specific example, a diamine of the formula (I) wherein each of Y¹ and Y² is a primary amino group, the remaining portions of 1- to 8-positions of the carbazole structure are occupied by hydrogen atoms, and X is a hydrogen atom, may be mentioned. More specifically, 1,5-diaminocarbazole, 1,6-diaminocarbazole, 1,7-diaminocarbazole, 1,8-diaminocarbazole, 2,5-diaminocarbazole, 2,6-diaminocarbazole, 2,7-diaminocarbazole, 3,5-diaminocarbazole, 3,6-diaminocarbazole or 4,5-diaminocarbazole may be mentioned. Among these diaminocarbazoles, 3,6-diaminocarbazole is most preferred which has a high reactivity with a tetracarboxylic dianhydride and whereby a polymer having a high molecular weight can be obtained.

The diamine to be used to obtain the specific polymer of the present invention, is required to contain at least one diamine having a structure represented by the formula (I). In a case where a plurality of diamines are used in combination, other diamines may be used in combination. Such other diamines are not particularly limited, but their specific examples may be an aromatic diamine such as p-phenylenediamine, m-phenylenediamine, 2,5-diaminotoluene, 2,6-diaminotoluene, 4,4′-diaminobiphenyl, 3,3′-dimethyl-4,4′-diaminobiphenyl, 3,3′-dimethoxy-4,4′-diaminobiphenyl, diaminodiphenylmethane, diaminodiphenyl ether, 2,2′-diaminodiphenylpropane, bis(3,5-diethyl-4-aminophenyl)methane, diaminodiphenylsulfone, diaminobenzophenone, diaminonaphthalene, 1,4-bis(4-aminophenoxy)benzene, 1,4-bis(4-aminophenyl)benzene, 9,10-bis(4-aminophenyl)anthracene, 1,3-bis(4-aminophenoxy)benzene, 4,4′-bis(4-aminophenoxy)diphenylsulfone, 2,2-bis[4-(4-aminophenoxy)phenyl]propane, 2,2-bis(4-aminophenyl)hexafluoropropane, or 2,2-bis[4-(4-aminophenoxy)phenyl]hexafluoropropane, an alicyclic diamine such as bis(4-aminocyclohexyl)methane, or bis(4-amino-3-methylcyclohexyl)methane, an aliphatic diamine such as 1,2-diaminoethane, 1,3-diaminopropane, 1,4-diaminobutane, or 1,6-diaminohexane, and a silicon diamine such as 1,3-bis(3-aminopropyl)-1,1,3,3-tetramethyldicycloxane. Further, for the purpose of increasing the tilt angle of liquid crystal, a diamine having an alkyl group, a fluoroalkyl group, a steroid skeleton or the like in its side chain may also be used in combination. The degree of the tilt angle of liquid crystal changes depending upon the size of the side chain or the amount of introduction, of such a diamine having a side chain. However, if the carbon number of the side chain of the diamine is less than 6, the effect of its introduction can not be expected. In a case where the carbon number is at least 6, and the amount of such a diamine is at least 5 mol %, the effect of its introduction is large, such being preferred.

The proportion of the diamine having a structure represented by the formula (I) based on all diamines to be used for the specific polymer, is preferably from 5 to 100 mol %, more preferably from 30 to 100 mol %. If the proportion of the diamine having a structure represented by the formula (I) is small, there may be a case where the effect to reduce charge accumulation can not adequately be obtained.

The tetracarboxylic dianhydride to be used to obtain the specific polymer of the present invention may be one tetracarboxylic dianhydride or a combination of a plurality of tetracarboxylic dianhydrides. The structure of such a tetracarboxylic dianhydride is not particularly limited. However, it is preferred to employ at least one tetracarboxylic dianhydride represented by the following formula (II): 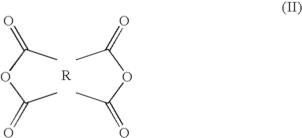
wherein R is a tetravalent organic group having an alicyclic structure.

By using the tetracarboxylic dianhydride represented by the formula (II), the rubbing durability and the voltage retention property of the liquid crystal alignment film obtainable from the liquid crystal alignment treating agent of the present invention, will further be improved. Here, the proportion of the tetracarboxylic dianhydride represented by the formula (II) based on all tetracarboxylic dianhydrides to be used for the specific polymer, is preferably from 20 to 100 mol %, more preferably from 50 to 100 mol %. If the proportion of the tetracarboxylic dianhydride represented by the formula (II) is less than 20 mol %, the effect to further improve the rubbing durability and the voltage retention property tends to be small.

Preferred examples of the tetracarboxylic dianhydrides represented by the formula (II) include dianhydrides of e.g. 1,2,3,4-cyclobutanetetracarboxylic acid, 1,3-dimethyl-1,2,3,4-tetracarboxycyclobutane, 1,2,3,4-cyclopentane tetracarboxylic acid, 1,2,4,5-cyclohexane tetracarboxylic acid, 2,3,5-tricarboxycyclopentyl acetic acid, 3,4-dicarboxy-1,2,3,4-tetrahydro-1-naphthalene succinic acid and bicyclo[3,3,0]octane-2,4,6,8-tetracarboxylic acid.

Further, specific examples of other tetracarboxylic dianhydrides which may be used for the specific polymer, include dianhydrides of aromatic tetracarboxylic acids such as pyromellitic acid, 2,3,6,7-naphthalene tetracarboxylic acid, 1,2,5,6-naphthalene tetracarboxylic acid, 1,4,5,8-naphthalene tetracarboxylic acid, 2,3,6,7-anthracene tetracarboxylic acid, 1,2,5,6-anthracene tetracarboxylic acid, 3,3′,4,4′-biphenyl tetracarboxylic acid, 2,3,3′,4′-biphenyl tetracarboxylic acid, bis(3,4-dicarboxyphenyl) ether, 3,3′,4,4′-benzophenone tetracarboxylic acid, bis(3,4-dicarboxyphenyl)sulfone, bis(3,4-dicarboxyphenyl)methane, 2,2-bis(3,4-dicarboxyphenyl)propane, 1,1,1,3,3,3-hexafluoro-2,2-bis(3,4-dicarboxyphenyl)propane, bis(3,4-dicarboxyphenyl)dimethylsilane, bis(3,4-dicarboxyphenyl)diphenylsilane, 2,3,4,5-pyridine tetracarboxylic acid and 2,6-bis(3,4-dicarboxyphenyl)pyridine, and dianhydrides of aliphatic tetracarboxylic acids, such as 1,2,3,4-butane tetracarboxylic acid.

The method for reacting the tetracarboxylic dianhydride with the diamine to obtain the specific polymer of the present invention, is not particularly limited. However, a method of reacting the tetracarboxylic dianhydride with the diamine in an organic solvent to obtain a polyamic acid, is simple and preferred.

The method of reacting the tetracarboxylic dianhydride with the diamine in an organic solvent, may, for example, be a method wherein a solution having the diamine dispersed or dissolved in an organic solvent, is stirred, and the tetracarboxylic dianhydride is added thereto as it is or as dispersed or dissolved in an organic solvent, a method wherein inversely, the diamine is added to a solution having the tetracarboxylic dianhydride dispersed or dissolved in an organic solvent, or a method wherein the tetracarboxylic dianhydride and the diamine are alternately added. In the present invention, any one of these methods may be employed. Further, when a plurality of compounds are to be used as the tetracarboxylic dianhydrides or as the diamines, they may be reacted in a state where they are preliminarily mixed, or they may individually sequentially be reacted.

In the case where the tetracarboxylic dianhydride is reacted with the diamine in an organic solvent, the reaction temperature is usually from 0 to 150° C., preferably from 5 to 100° C. Further, the reaction can be carried out at an optional concentration, but if the concentration is too low, it tends to be difficult to obtain a polymer having a high molecular weight, and if the concentration is too high, the viscosity of the reaction solution is likely to be too high to carry out uniform stirring. Therefore, it is preferably from 1 to 50 wt %, more preferably from 5 to 30 wt %. The reaction may be carried out at a high concentration at the initial stage of the reaction, and then an organic solvent may be added.

The organic solvent to be used for the above reaction is not particularly limited so long as it is capable of dissolving the formed polymer. However, specific examples thereof include N,N-dimethylformamide, N,N-dimethylacetamide, N-methyl-2-pyrrolidone, N-methylcaprolactam, dimethylsulfoxide, tetramethylurea, pyridine, dimethylsulfone, hexamethylsulfoxide and γ-butyrolactone. They may be used alone or in combination as a mixture. Further, even a solvent which is incapable of dissolving the polyamic acid, may be used as mixed with the above solvent within such a range that the formed polyamic acid will not precipitate. Further, moisture in the organic solvent may impair the polymerization reaction and may cause hydrolysis of the formed polyamic acid. Accordingly, as the organic solvent, it is preferred to employ one which has been dehydrated and dried.

The ratio of the tetracarboxylic dianhydride to the diamine to be used for the reaction for the synthesis of a polyamic acid is preferably from 1:0.8 to 1:1.2 by molar ratio. Like in a usual polycondensation reaction, the molecular weight of the polyamic acid becomes large, as this molar ratio tends to be close to 1:1.

If the molecular weight of the polyamic acid is too small, the strength of the coating film thereby obtainable may sometimes be inadequate. On the other hand, if the molecular weight of the polyamic acid is too large, the viscosity of the liquid crystal alignment treating agent thereby obtainable may sometimes be too high, whereby the operation efficiency during formation of the coating film or the uniformity of the coating film is likely to be poor. Accordingly, the reduced viscosity of the polyamic acid (as measured at 30° C. in N-methyl-2-pyrrolidone (NMP) at a concentration of 0.5 dl/g) to be used for the liquid crystal alignment treating agent of the present invention, is preferably from 0.1 to 2.0, more preferably from 0.2 to 1.5.

The specific polymer to be incorporated in the liquid crystal alignment treating agent of the present invention may be the polyamic acid obtained as described above, but it may be a polyimide having such a polyamic acid cyclodehydrated by heating or by means of a catalyst. However, depending upon the structure of the polyamic acid, there may be a case wherein it will be insolubilized by the imidation reaction, whereby it tends to be difficult to be used for a liquid crystal alignment treating agent. In such a case, not all of amic acid groups in the polyamic acid may be imidated, and imidation may be carried out within a range where a proper solubility can be maintained.

The imidation reaction for cyclodehydration of the polyamic acid is usually carried out by thermal imidation wherein a solution of the polyamic acid is heated as it is, or by chemical imidation wherein a catalyst is added to a solution of the polyamic acid. The chemical imidation where the imidation reaction proceeds at a relatively low temperature, is preferred, since decrease in the molecular weight of the obtainable polyimide is thereby less likely to occur.

Such chemical imidation can be carried out by reacting a polyamic acid in an organic solvent in the presence of a basic catalyst and an acid anhydride at a reaction temperature of from −20 to 250° C., preferably from 0 to 180° C., for a reaction time of from 1 to 100 hours. The amount of the basic catalyst is usually from 0.5 to 30 times, preferably from 2 to 20 times, by mol to amic acid groups, and the amount of the acid anhydride is usually from 1 to 50 times, preferably from 3 to 30 times, by mol to amic acid groups. If the amount of the basic catalyst or the acid anhydride is small, the reaction may not adequately proceed, and if it is too much, it tends to be difficult to remove it completely after completion of the reaction. As the basic catalyst to be used here, pyridine, triethylamine, trimethylamine, tributylamine or trioctylamine, may, for example, be mentioned. Among them, pyridine is preferred, since it has a proper basicity to let the reaction proceed. As the acid anhydride, acetic anhydride, trimellitic anhydride or pyromellitic anhydride, may, for example, be mentioned. Among them, it is preferred to employ acetic anhydride, whereby purification after completion of the reaction will be easy. As the organic solvent, the above-described solvent to be used for the preparation of a polyamic acid, may be used. The imidation degree by chemical imidation can be controlled by adjusting the amount of the catalyst, the reaction temperature or the reaction time.

For the liquid crystal alignment treating agent of the present invention, the reaction solution of the polyamic acid or the polyimide, obtained as described above, may be used as it is. However, the reaction solution may be put into a poor solvent, so that the specific polymer may be precipitated, recovered and re-dissolved for use. Especially, in the polyimide solution after the chemical imidation, the basic catalyst or the acid anhydride remains, and it is preferred to precipitate and recover the polyimide for use. The poor solvent to be used at that time is not particularly limited, but, methanol, acetone, hexane, butyl cellosolve, heptane, methyl ethyl ketone, methyl isobutyl ketone, ethanol, toluene or benzene may, for example, be mentioned. The polymer component precipitated by putting it in the poor solvent, is recovered by filtration and then dried under atmospheric pressure or reduced pressure at room temperature or under heating to obtain a powder. Further, an operation of re-dissolving the precipitated and recovered polymer in an organic solvent, followed by reprecipitation for recovery, may be repeated for 2 to 10 times, whereby impurities in the polymer can be minimized. In such a case, it is preferred to employ at least three types of poor solvents such as alcohols, ketones or hydrocarbons, as the poor solvents, whereby the purification efficiency will be further increased.

The solvent to re-dissolve the recovered specific polymer is not particularly limited so long as it is one wherein the specific polymer is soluble. However, its specific examples include N,N-dimethylformamide, N,N-dimethylacetamide, N-methyl-2-pyrrolidone, N-methylcaprolactam, 2-pyrrolidone, N-ethylpyrrolidone, N-vinylpyrrolidone, dimethylsulfoxide, tetramethylurea, pyridine, dimethylsulfone, hexamethylsulfoxide and γ-butyrolactone. They may be used alone or in combination as a mixture of two or more of them.

The liquid crystal alignment treating agent of the present invention is one obtained by adjusting the concentration of the solution of the specific polymer obtained as described above. The solid content concentration of the liquid crystal alignment treating agent of the present invention may suitably be changed depending upon the predetermined thickness of the liquid crystal alignment film to be formed, and it is preferably from 1 to 10 wt %. If it is less than 1 wt %, it tends to be difficult to form a coating film which is uniform and free from defects, and if it exceeds 10 wt %, the storage stability of the solution may sometimes be poor.

The solvent to be used for adjusting the concentration may be the above-mentioned solvent for re-dissolving the specific polymer. Further, even a solvent which is incapable of dissolving the specific polymer by itself, may be used as mixed within a range not to precipitate the polymer component. Especially, it is known that the uniformity of the coating film at the time of coating will be improved by incorporating in a proper degree a solvent having a low surface tension such as ethyl cellosolve, butyl cellosolve, ethylcarbitol, butylcarbitol, ethylcarbitol acetate, ethylene glycol, 1-methoxy-2-propanol, 1-ethoxy-2-propanol, 1-butoxy-2-propanol, 1-phenoxy-2-propanol, butylene glycol monoacetate, propylene glycol diacetate, propylene glycol-1-monomethyl ether-2-acetate, propylene glycol-1-monoethyl ether-2-acetate, dipropylene glycol, 2-(2-ethoxypropoxy)propanol, methyl lactate, ethyl lactate, n-propyl lactate, n-butyl lactate or isoamyl lactate. Also in the liquid crystal alignment treating agent of the present invention, this is suitably employed in a case where it is difficult to form a uniform coating film with the single solvent composition.

Further, to the liquid crystal alignment treating agent of the present invention, an additive such as a silane coupling agent may be added in order to improve the adhesion of the coating film to the substrate. Further, two or more specific polymers may be mixed, or other polymer components may be added.

The liquid crystal alignment treating agent of the present invention obtained as described above may be filtered, then applied to a substrate, dried and baked to form a coating film, and this coating film surface is subjected to rubbing treatment, whereupon it is used as a liquid crystal alignment film for nematic liquid crystal.

The substrate to be used here is not particularly limited so long as it is a substrate having high transparency. A glass substrate or a plastic substrate such as an acrylic substrate or a polycarbonate substrate, may, for example, be used. With a view to simplifying the process, it is preferred to employ a substrate having ITO electrodes, etc. formed to drive liquid crystal. Further, in the case of a reflection type liquid crystal display device, an opaque substance such as a silicon wafer may be used for a substrate on one side only, and in such a case, for the electrodes, a material which reflects light, such as aluminum may also be used.

As the method for coating the liquid crystal alignment treating agent, a spin coating method, a printing method or an ink jet method may, for example, be mentioned. From the viewpoint of the productivity, a transfer printing method is widely used industrially, and it can also suitably be used with the liquid crystal alignment treating agent of the present invention.

The drying step after coating the liquid crystal alignment treating agent is not necessarily required. However, it is preferred to incorporate a drying step in a case where the time until baking after the coating is not constant for every substrate or in a case where baking is not immediately carried out after the coating. This drying is sufficient if the solvent is evaporated to such an extent that the shape of the coating film undergoes no change by e.g. transportation of the substrate, and the drying means is not particularly limited. Specifically, a method of drying on a hot plate of from 50 to 150° C., preferably from 80 to 120° C., for from 0.5 to 30 minutes, preferably from 1 to 5 minutes, may be adopted.

Baking of the liquid crystal alignment treating agent may be carried out at an optional temperature of from 100 to 350° C., preferably from 150° C. to 300° C., more preferably from 200° C. to 250° C. In a case where the liquid crystal alignment treating agent contains a polyamic acid, the conversion of the polyamic acid to a polyimide changes depending upon this baking temperature. However, in the present invention, the liquid crystal alignment treating agent may not necessarily be imidated 100%. However, it is preferred to carry out the baking at a temperature higher by at least 10° C. than the temperature for heat treatment for e.g. curing the sealing agent, which is required in the process for preparing a liquid crystal cell.

The thickness of the coating film after the baking is usually from 5 to 300 nm, preferably from 10 to 100 nm, since if it is too thick, such is disadvantageous from the viewpoint of the power consumption of the liquid crystal display device, and if it is too thin, the reliability of the liquid crystal display device may sometimes decrease.

The coating film of the liquid crystal alignment treating agent of the present invention may be made to be a liquid crystal alignment film for nematic liquid crystal by rubbing treatment i.e. an operation of rubbing the coating film surface in a predetermined direction with a commercially available rubbing cloth. The material for the rubbing cloth may, for example, be nylon, rayon or cotton, but it is not particularly limited thereto.

The liquid crystal display device of the present invention is one obtained by preparing a liquid crystal cell, as a liquid crystal display device, by a known method by using a nematic liquid crystal, after obtaining the substrate having the liquid crystal alignment film from the liquid crystal alignment treating agent of the present invention by the above-described method. As an example for preparation of the liquid crystal cell, a method is common wherein a pair of substrates having liquid crystal alignment films formed thereon are disposed with a spacer of from 1 to 30 μm, preferably from 2 to 10 μm, interposed, so that the rubbing directions will take an optional angle of from 0 to 270°, the periphery is fixed by a sealing agent, then liquid crystal is injected, followed by sealing. The method for injecting liquid crystal is not particularly limited, and a vacuum method wherein liquid crystal is injected after evacuating the interior of the liquid crystal cell prepared, or a dropping method wherein after dropping liquid crystal, sealing is carried out, may, for example, be mentioned.

The liquid crystal display device thus prepared by using the liquid crystal alignment treating agent of the present invention, has excellent electrical properties and thus can be made to be a liquid crystal display device which is less susceptible to decrease of the contrast or persistence of vision. For example, it is useful for display devices of various systems employing nematic liquid crystal, such as TN devices, STN devices, TFT liquid crystal devices, as well as lateral electric field type liquid crystal display devices and vertical alignment type liquid crystal devices.

Now, the present invention will be described in further detail with reference to Examples. However, it should be understood that the present invention is by no means restricted thereto. In the following, the reduced viscosities of polyamic acids are values measured at 30° C. in NMP at a concentration of 0.5 dl/g.

### EXAMPLES

### Preparation Example 1

In a nitrogen stream, in a 100 mL four-necked flask, 0.99 g (0.005 mol) of 3,6-diaminocarbazole (hereinafter referred to simply as DCA) was dissolved in 10 g of N-methyl-2-pyrrolidone (hereinafter referred to simply as NMP), and then a solution having 0.94 g (0.0048 mol) of 1,2,3,4-cyclobutane tetracarboxylic dianhydride (hereinafter referred to simply as CBDA) suspended in 7.35 g of NMP, was put, followed by polymerization for 20 hours to obtain a solution of polyamic acid (A-1). The polymerization reaction proceeded easily and uniformly, and the reduced viscosity of this polyamic acid was 1.50 dl/g.

### Preparation Example 2

In a nitrogen stream, in a 100 mL four-necked flask, 1.06 g (0.0054 mol) of DCA and 0.23 g (0.0006 mol) of 1,3-diamino-4-octadecyloxybenzene were dissolved in 10 g of NMP, and then, a solution having 1.15 g (0.0059 mol) of CBDA suspended in 7.35 g of NMP, was put, followed by polymerization for 20 hours to obtain a solution of polyamic acid (A-2). The polymerization reaction proceeded easily and uniformly, and the reduced viscosity of this polyamic acid was 1.20 dl/g.

### Preparation Example 3

In a nitrogen stream, in a 100 mL four-necked flask, 0.95 g (0.0048 mol) of CDA and 1.43 g (0.0072 mol) of 4,4′-diaminodiphenylmethane (hereinafter referred to simply as DDM) were dissolved in 15 g of NMP, and then a solution having 2.34 g (0.0119 mol) of CBDA suspended in 11.72 g of NMP, was put, followed by polymerization for 20 hours to obtain a solution of polyamic acid (A-3). The polymerization reaction proceeded easily and uniformly, and the reduced viscosity of this polyamic acid was 0.90 dl/g.

### Preparation Example 4

In a nitrogen stream, 10.38 g (0.096 mol) of p-phenylenediamine and 19.61 g (0.1 mol) of CBDA were reacted in 341.2 g of NMP at room temperature for 5 hours to obtain a solution of polyamic acid (B-1). The polymerization reaction proceeded easily and uniformly, and the reduced viscosity of this polyamic acid was 1.20 dl/g.

### Preparation Example 5

In a nitrogen stream, 10.91 g (0.1 mol) of 2,6-diaminopyridine and 19.52 g (0.0995 mol) of CBDA were reacted in 121.7 g of NMP at room temperature for 20 hours to obtain a solution of polyamic acid (B-2). The reduced viscosity of the obtained polyamic acid was 0.55 dl/g.

### Preparation Example 6

In a nitrogen stream, 13.88 g (0.07 mol) of DDM and 13.66 g (0.0696 mol) of CBDA were reacted in 156.04 g of NMP at room temperature for 20 hours to obtain a solution of polyamic acid (B-3). The polymerization reaction proceeded easily and uniformly, and the reduced viscosity of this polyamic acid was 1.10 dl/g.

### Example 1

The solution of polyamic acid (A-1) obtained in Preparation Example 1, was diluted with NMP to obtain a liquid crystal alignment treating agent of the present invention having a resin concentration of 4 wt %.

### Preparation of Liquid Crystal Cell

The above liquid crystal alignment treating agent was applied by spin coating on the ITO surface of a glass substrate provided with ITO electrodes, dried at 80° C. for 5 minutes and then baked at 250° C. for 60 minutes to obtain a coating film having a thickness of 100 nm. The coating film surface was subjected to rubbing treatment is by a rubbing apparatus having a roll diameter of 120 mm with a rayon cloth under such conditions that the rotational speed was 500 rpm, the mobile speed was 20 mm/sec and the pressing amount of 0.6 mm, to obtain a liquid crystal alignment film. Two sheets of such a substrate provided with the liquid crystal alignment film, were prepared. A spacer having a diameter of 6 μm was applied to the liquid crystal alignment film surface of one substrate. Then, the two substrates were combined so that the rubbing directions crossed each other, and the periphery was sealed except for the injection inlet for liquid crystal, to obtain a vacant cell having a cell gap of 6 μm. To this cell, nematic liquid crystal (MLC-2003C, manufactured by Merck), was injected under vacuum at room temperature, and the injection inlet was sealed to obtain a twist nematic liquid crystal cell.

### Evaluation of Rubbing Durability and Liquid Crystal Orientation Property

Evaluation of the rubbing durability was carried out by observing the surface of the liquid crystal alignment film after the rubbing treatment, by a polarizing microscope, whereby one having scraping of the film observed, was regarded as “no good”. Further, evaluation of the liquid crystal alignment property was carried out by observing the liquid crystal cell immediately after the preparation under crossed Nicols, whereby one having disoriented alignment observed was regarded as “no good”.

### Evaluation of Voltage Retention and Charge Accumulation

Evaluation of the voltage retention was carried out by applying a voltage of 4 V for 60 μsec to a liquid crystal cell set at a temperature of 23° C. or 90° C. and measuring the voltage upon expiration of 16.67 msec, whereby the percentage of the voltage maintained was calculated as the voltage retention. Further, evaluation of the charge accumulation was carried out by applying rectangular waves of 30 Hz/±3 V having direct current 3 V superimposed, at 23° C. for 60 minutes and measuring the accumulated voltage remaining in the liquid crystal cell immediately after switching off the direct current voltage of 3 V, by an optical flicker elimination method.

As a result of the above evaluation, no scraping was observed on the film after rubbing, and no disoriented alignment was observed in the liquid crystal cell. Further, this liquid crystal cell had a voltage retention of 99% at 23° C. and a voltage retention of 96% at 90° C., and the accumulated voltage was 0 V. This result is also shown in Table 1 given hereinafter.

### Example 2

A liquid crystal cell was prepared and evaluated in the same manner as in Example 1 except that in Example 1, the baking of the coating film was carried out at 220° C. for 30 minutes. The results of evaluation are shown in Table 1 given hereinafter.

### Example 3

The solution of polyamic acid (A-2) obtained in Preparation Example 2 was diluted with NMP to obtain a liquid crystal alignment treating agent of the present invention having a resin concentration of 4 wt %. Using this liquid crystal alignment treating agent, a liquid crystal cell was prepared and evaluated in the same manner as in Example 1. The results of evaluation are shown in Table 1 given hereinafter.

### Example 4

The solution of polyamic acid (A-3) obtained in Preparation Example 3 was diluted with NMP to obtain a liquid crystal alignment treating agent of the present invention having a resin concentration of 4 wt %. Using this liquid crystal alignment treating agent, a liquid crystal cell was prepared and evaluated in the same manner as in Example 1. The results of evaluation are shown in Table 1 given hereinafter.

### Comparative Example 1

The solution of polyamic acid (B-1) obtained in Preparation Example 4 was diluted with NMP to obtain a liquid crystal alignment treating agent having a resin concentration of 4 wt %. Using this liquid crystal alignment treating agent, a liquid crystal cell was prepared and evaluated in the same manner as in Example 1. The results of evaluation are shown in Table 1 given hereinafter.

### Comparative Example 2

The solution of polyamic acid (B-2) obtained in Preparation Example 5 was diluted with NMP to obtain a liquid crystal alignment treating agent having a resin concentration of 4 wt %. Using this liquid crystal alignment treating agent, a liquid crystal cell was prepared and evaluated in the same manner as in Example 1. The results of evaluation are shown in Table 1 given hereinafter.

### Comparative Example 3

The solution of polyamic acid (B-3) obtained in Preparation Example 6 was diluted with NMP to obtain a liquid crystal alignment treating agent having a resin concentration of 4 wt %. Using this liquid crystal alignment treating agent, a liquid crystal cell was prepared and evaluated in the same manner as in Example 1. The results of evaluation are shown in Table 1 given hereinafter.

TABLE 1

| | | Voltage | | Accumu- | Liquid | |
|---|---|---|---|---|---|---|
| | | retention | | lated | crystal | |
| | | (%) | | voltage | orientation | Rubbing |
| | Polymer | 23° C. | 90° C. | (V) | property | durability |
| Ex. | | | | | | |
| 1 | A-1 | 99 | 96 | 0 | Good | Good |
| 2 | A-1 | 99 | 86 | 0 | Good | Good |
| 3 | A-2 | 99 | 97 | 0 | Good | Good |
| 4 | A-3 | 99 | 94 | 0.2 | Good | Good |
| Comp. | | | | | | |
| Ex. | | | | | | |
| 1 | B-1 | 99 | 77 | 0.8 | Good | No good |
| 2 | B-2 | 99 | 93 | 0.3 | No good | No good |
| 3 | B-3 | 99 | 88 | 1.5 | Good | Good |

### INDUSTRIAL APPLICABILITY

By the liquid alignment treating agent of the present invention, it is possible to obtain a liquid alignment film which, in its applications to various display devices employing nematic liquid crystal, is excellent in voltage retention, has a reduced charge accumulation and is excellent in durability against rubbing treatment. A liquid crystal display device employing the liquid crystal alignment film of the present invention is less susceptible to deterioration of the contrast or persistence of vision and thus is useful as a display device of a various system employing nematic liquid crystal, such as a TN device, a STN device, a TFT liquid crystal device, or a lateral electric field type liquid crystal display device or a vertical alignment type liquid crystal display device.

1. A liquid crystal alignment treating agent to obtain an alignment film for nematic liquid crystal by rubbing treatment after forming a coating film, characterized in that it comprises at least one polymer selected from a polyamic acid obtained by reacting one or more tetracarboxylic dianhydrides with one or more diamines comprising at least one diamine having a structure represented by the following formula (I), and a polyimide obtained by cyclodehydration of such a polyamic acid: 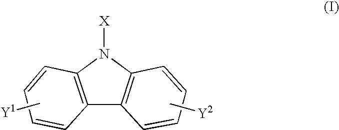
wherein X is a hydrogen atom or a monovalent organic group, and each of Y¹ and Y² is a primary amino group or a monovalent organic group having one primary amino group.

2. The liquid crystal alignment treating agent according to claim 1, wherein the diamine having a structure represented by the formula (I) is 3,6-diaminocarbazole.

3. The liquid crystal alignment treating agent according to claim 1, wherein said one or more tetracarboxylic dianhydrides are one or more tetracarboxylic dianhydrides comprising at least one tetracarboxylic dianhydride represented by the following formula (II): 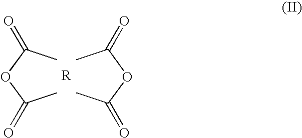
wherein R is a tetravalent organic group having an alicyclic structure.

4. A liquid crystal display device obtained by applying the liquid crystal alignment treating agent as defined in any one of claims 1 to 4 to a pair of substrates having electrodes, to form coating films, rubbing the coating film surfaces to form liquid crystal alignment films, and sandwiching nematic liquid crystal between the liquid crystal alignment films formed on the pair of substrates.
